(19) United States
(12) Patent Application Publication
(10) Pub. No.: US 2023/0350709 A1
(43) Pub. Date: Nov. 2, 2023

(54) CLOUD SAFETY COMPUTING METHOD, DEVICE AND STORAGE MEDIUM BASED ON CLOUD FAULT-TOLERANT TECHNOLOGY

(71) Applicant: Beijing Jiaotong University, Beijing (CN)

(72) Inventors: Li ZHU, Beijing (CN); Song LI, Beijing (CN); Tao TANG, Beijing (CN); Xi WANG, Beijing (CN); Hongwei WANG, Beijing (CN); Tao WEN, Beijing (CN)

(21) Appl. No.: 17/871,021

(22) Filed: Jul. 22, 2022

(30) Foreign Application Priority Data
Apr. 28, 2022 (CN) 2022104613930

(51) Int. Cl. G06F 9/455

(52) U.S. Cl. CPC G06F 9/45558; G06F 9/45545; G06F 2009/4557; G06F 2009/45587

(57) ABSTRACT

Disclosed are a cloud safety computing method, a device and a storage medium based on cloud fault-tolerant technology. The cloud safety computing method includes following steps: S1, adopting a one-master multiple-slave fault-tolerant architecture for management nodes, and using KeepAlived and Haproxy to realize a liveness self-check of the management nodes and a load balancing of user requests, and S2, adopting a dynamic redundancy fault-tolerant safety design for service nodes to maintain a life cycle of application microservices, and giving feedback on liveness information to the management nodes in real time through heartbeat by the service nodes, where the application microservices report the life cycle to the management nodes based on a probe mechanism, and the application microservices exchange input and output information through redundancy voting.

### CROSS-REFERENCE TO RELATED APPLICATIONS

This application claims priority to Chinese Patent Application No. 202210461393.0, filed on Apr. 28, 2022, the contents of which are hereby incorporated by reference.

### TECHNICAL FIELD

The present application belongs to the field of electrified transportation, and in particular relates to a cloud safety computing method, a device and a storage medium based on a cloud fault-tolerant technology.

### BACKGROUND

As an innovative service mode of information technology, cloud computing is a delivery and use mode of IT infrastructure, and is widely used in all walks of life because it provides corresponding infrastructure resources according to needs of users, and at the same time, users “pay on demand” to utilize the corresponding resources. Cloud computing has the characteristics of super-scale, virtualization, high availability, universality, high scalability and on-demand service, which may greatly improve the utilization efficiency of existing resources. With advantages of unified deployment of business applications and centralized management of data, cloud computing is engaged in core management and application business in many industrial control systems and application services. However, although cloud computing improves resource utilization by integrating system resources, when faced with safety-critical business, conventional cloud computing methods have to face a risk of a single point of failure in cluster management due to native architecture and a risk of failure in application microservices due to dynamic allocation of equipment resources. Therefore, it is necessary to have an effective and reliable cloud safety computing method to ensure the cloud computing platform reliable.

Due to unavailability of an effective cloud safety computing method, the conventional general cloud computing technology can't meet index requirements of application Reliability, Availability, Maintainability and Safety (RAMS). In order to fulfill RAMS index requirements of cloud computing, two main technical problems are to be solved currently as follows:

1) how to realize failure prevention and node recovery management of the virtual hypervisor and underlying hardware;

2) how to realize a design concept of fault-oriented safety of virtual application services, and how to realize fault management and fault-tolerant recovery measures of applications.

In order to ensure the availability of microservice applications on cloud computing platform, some measures are required to prevent, check, eliminate and recover possible faults during the present application operation. From the processing flow of cloud fault management, common fault management technologies include fault elimination, fault prediction and avoidance and fault tolerance. Measures for fault elimination are to eliminate a source of the fault in advance, and to check the fault in advance before it occurs. Fault prediction and avoidance refers to the real-time detection of possible fault points or the prediction based on real-time state data during the life cycle of application services, and the fault cutting-off in advance. Fault tolerance emphasizes that after a fault occurs, certain reserved measures should be taken to offset the negative effects brought by the fault and recover it. In time domain, three technologies mentioned above can be executed successively. However, in the actual application running environment, the fault sources and causes are not obvious, and real-time polling detection of a large number of fault sources also greatly wastes resources. Therefore, improving the response time and execution efficiency of fault tolerance has become a focus of cloud fault management.

However, from the activation sequence of cloud fault tolerance, it may be divided into active fault-tolerant mechanism and passive fault-tolerant mechanism. Passive fault-tolerant mechanism, as its name implies, is triggered when a fault occurs. Common passive fault-tolerant mechanism of cloud platform includes fault checking, fault restart, hot standby, warm standby and cold standby, duplex and request retry. The active fault-tolerant mechanism is to take measures similar to live migration in advance according to platform state data to prevent platform failure or software errors in advance.

### SUMMARY

The present application aims to provide a cloud safety computing method, a device and a storage medium based on cloud fault-tolerant technology, so as to overcome technical problems in an existing cloud computing platform.

In order to achieve the above objectives, the present application adopts following technical scheme:

a cloud safety computing method based on cloud fault-tolerant technology adopts double fault-tolerant technology of management fault-tolerant and application fault-tolerant and includes the following steps:

S1, adopting a one-master multiple-slave fault-tolerant architecture for management nodes by a management fault-tolerant technology, and using KeepAlived and Haproxy to realize a liveness self-check of the management nodes and a load balancing of user requests, so as to ensure management nodes to work reliably; and

S2, adopting a dynamic redundancy fault-tolerant safety design for service nodes to maintain a life cycle of application microservices, and giving feedback on liveness information the management nodes in real time through heartbeat by the service nodes.

The application microservices report the life cycle to the management nodes based on a probe mechanism, and the application microservices exchange input and output information through redundancy voting to ensure safe and correct user data reception and processing.

Optionally, in S1, the management fault-tolerant technology selects a one-master multiple-slave architecture to ensure a high availability of cluster master management nodes. Under the one-master multiple-slave architecture, a master management node performs all management functions, and most slave nodes are in a hot standby state.

Optionally, in S1, the Haproxy is responsible for network proxy, forwarding user requests, and recording and counting throughput, state, and startup and shutdown times of a monitoring object apiserver. Keepalived, as a reverse proxy server, periodically detects a running state of the Haproxy by dual-machine hot standby.

Optionally, in S1, the management fault-tolerant technology adopts an adjustable weight method to elect the master management node. There is an odd number of management nodes in total, and each management node gets an identity weight. Once a node is down or restarts, its identity weight is reduced or increased according to an adjustment strategy, and a successor with high identity weight is the master management node.

Optionally, in S2, the application fault-tolerant technology adopts the redundancy principle of two out of N to design a secure computing platform of an application layer, where N is larger than or equal to 2. The secure computing platform is composed of several virtual hosts, and the virtual hosts call an input and output of user services through interfaces and vote synchronously. The application fault-tolerant technology adopts a fault-tolerant mechanism of taking two out of N redundancy, where taking two out of N is continuously downgraded, and is gradually downgraded to taking two out of N-1 and taking two out of N-2, and a buffer time is given for fault handling. Input and output voting are carried out in N virtual hosts, and a host with a first successful voting is preferred as the application output host, so as to avoid a data conflict between multiple hosts and a client. The passive fault-tolerant mechanism of dynamic redundancy is adopted to ensure a rapid recovery of services in a fault state. A failure monitoring of a single host is realized by self-check in virtualized hosts and heartbeat among virtualized hosts, and internal reorganization and fault tolerance are realized by destroying and replacing a failed host.

Optionally, a ready probe and a liveness probe are adopted to realize the health check of the secure computing platform including user services at intervals in a whole life cycle. The ready probe is responsible for checking whether the virtual hosts are ready to start and start working normally, and the liveness probe is responsible for probing whether the virtual hosts are alive.

Optionally, when the virtual hosts fail, a replica is restarted and nodes are migrated. When virtual hosts fail and a physical resources of nodes where virtual hosts are located are sufficient, Docker container technology is used to create initialized replica virtual hosts by using a mirroring. If infrastructure resources of the nodes restarted are insufficient, the virtual hosts migrate to other surviving services nodes to achieve load balancing.

Optionally, when the virtual hosts fail, data of the initialized replica virtual hosts is inherited from other virtual hosts. Each surviving virtual host is a memory variable storage area. Among them, an inherited data information includes: a communication address of a current output host, a communication address of a client receiving an output data, user service-related data and communication-related information.

The present application also provides a cloud safety computing device based on cloud fault-tolerant technology; the cloud safety computing device based on cloud fault-tolerant technology comprises:

a fault-tolerant management module used for the management nodes to adopt a one-master multi-slave fault-tolerant architecture, and to use KeepAlived and Haproxy to realize the liveness self-check of the management nodes and the load balancing of user requests,

an application fault-tolerant module, used for the service nodes to maintain the life cycle of the application microservices by adopting the dynamic redundancy fault-tolerant safety design, and giving feedback on the liveness information to the management nodes in real time through heartbeat.

The application microservices report the life cycle to the management nodes based on the probe mechanism, and the application microservices exchange input and output information through redundancy voting.

The present application also provides a storage medium. The storage medium stores machine executable instructions, and when the machine executable instructions are called and executed by a processor, the machine executable instructions urge the processor to realize the cloud safety computing method based on cloud fault-tolerant technology.

The present application has the following technical effects: odd number of management nodes realize distributed fault tolerance, and user requests are executed simultaneously; dynamic redundancy fault tolerance is adopted and mutual heartbeat monitoring is carried out; down failure of management nodes does not affect application operation; application and dependent running environment are containerized and packaged, which is light-weighted, easy to migrate and deploy, and quick to restart.

### BRIEF DESCRIPTION OF THE DRAWINGS

In order to explain the technical scheme of the embodiments of the present application more clearly, the following will briefly introduce the drawings that need to be used in the description of the embodiments. Obviously, the drawings in the following description are only some embodiments of the present application. For those of ordinary skill in the art, other drawings may be obtained according to these drawings without any creative effort.

FIG. 1 is a flowchart of a cloud safety computing method based on cloud fault-tolerant technology according to an embodiment of the present application.

FIG. 2 is a structural diagram of a cloud secure computing platform based on cloud fault-tolerant technology according to an embodiment of the present application.

FIG. 3 is a schematic diagram of a cloud management fault tolerance scheme according to an embodiment of the present application.

FIG. 4 is a schematic diagram of an adjustment process of identity weights in the case of downtime and restart according to an embodiment of the present application.

FIG. 5 is a process of fault-tolerant method of dynamic redundancy application in an embodiment of the present application.

FIG. 6 is a data inheritance timing during a fault recovery of an embodiment of the present application.

### DETAILED DESCRIPTION OF THE EMBODIMENTS

Embodiments of the present application will be described in detail below, Embodiments of which are shown in the accompanying drawings, in which the same or similar reference numerals refer to the same or similar elements or elements with the same or similar functions throughout. The embodiments described below with reference to the drawings are exemplary, only for explaining the present application, and should not be construed as limiting the present application.

Those skilled in the art can understand that the singular forms “a”, “an”, “the” and “that” used here can also include plural forms unless specifically stated. It should be further understood that the word “comprising” used in the specification of the present application refers to the presence of the features, integers, steps, operations, elements and/or components, but does not exclude the presence or addition of one or more other features, integers, steps, operations, elements, components and/or groups thereof. It should be understood that when a component is “connected” or “coupled” to another component, it may be directly connected or coupled to other components, or there may be intermediate components. In addition, as used herein, “connected” or “coupled” may include wireless connection or coupling. The expression “and/or” used here includes any unit and all combinations of one or more associated listed items.

It can be understood by those skilled in the art that unless otherwise defined, all terms (including technical terms and scientific terms) used here have the same meanings as those commonly understood by those skilled in the art to which this application belongs. It should also be understood that terms such as those defined in general dictionaries should be understood to have meanings consistent with those in the context of the prior art, and will not be interpreted with idealized or overly formal meanings unless defined as here.

In order to facilitate the understanding of the embodiments of the present application, several specific embodiments will be further explained with reference to the drawings, and each embodiment does not constitute a limitation on the embodiments of the present application.

### Embodiment 1

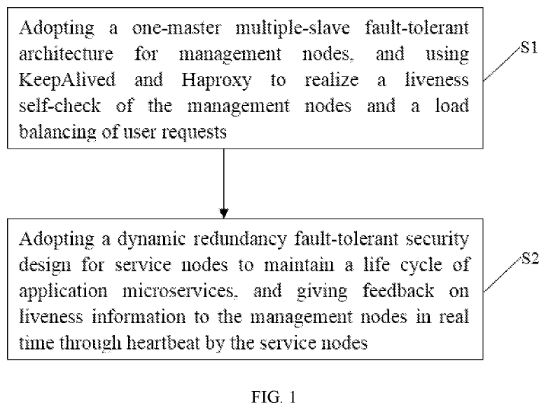

As shown in FIG. 1, an embodiment of the present application provides a cloud safety computing method based on cloud fault tolerance, and the cloud safety computing method based on cloud fault tolerance includes following steps:

S1, adopting a one-master multiple-slave fault-tolerant architecture for management nodes, and using KeepAlived and Haproxy to realize a liveness self-check of the management nodes and a load balancing of user requests; and

S2, adopting a dynamic redundancy fault-tolerant safety design for service nodes to maintain a life cycle of application microservices, and giving feedback on liveness information the management nodes in real time through heartbeat by the service nodes.

The application microservices report the life cycle to the management nodes based on a probe mechanism, and the application microservices exchange input and output information through redundancy voting.

The computing method of this embodiment optimizes the conventional cloud computing method, effectively improves the availability and reliability of conventional cloud computing platforms or cloud computing-based services, and further improves the reliability and stability of various industrial control systems based on cloud computing. Aiming at Reliability, Availability, Maintainability, Safety (RAMS) index, this safety computing method solves the difficulties of failure prevention and node recovery management of lower-level dependencies such as Hypervisor and underlying hardware, introduces the design concept of fault-oriented safety into virtual application services, and realizes application fault management and fault-tolerant recovery measures based on this concept. This safety computing method ensures the fault-tolerant architecture of cloud computing platform from multiple dimensions through the dual fault-tolerant technical architecture of management fault-tolerant and service fault-tolerant. At the same time, this safety computing method greatly reduces the risk of single-point failure faced by conventional cloud computing methods and the risk of failure in application microservices caused by dynamic allocation of equipment resources, so as to realize the overall improvement of the reliability and availability of cloud computing platform.

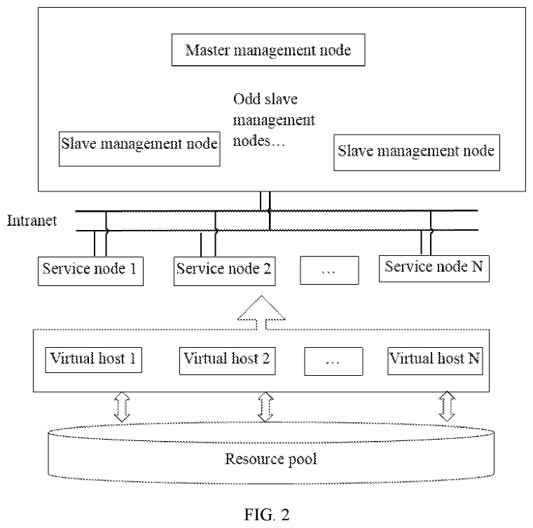

FIG. 2 is a structural diagram of a cloud secure computing platform based on cloud fault-tolerant technology provided by the embodiment of the present application.

A cloud platform architecture based on cloud fault-tolerant technology is a vertical multi-tier distributed architecture, including distributed cloud management center, distributed service nodes, virtual hosts and abstract physical resource pool.

The cloud management center externally executes and processes user requests, internally collects status information of service nodes and microservices applied on them, and stores application configuration metadata. The management nodes that constitute the cloud management center is only engaged in a resource allocation of application initialization, deployment node scheduling, application startup and runtime state acquisition, and reconstruction and migration during fault recovery.

Service nodes are physical nodes providing services, and running environment and resource requirements of all application microservices, including virtual hosts, are related to the service nodes. At the same time, the service nodes provide services without limitation, and the services may be customized according to needs of users.

Virtual hosts are an application microservices built by Server operating system. The virtual hosts exist dependent on service nodes. When the number of service nodes is larger than zero, the virtual hosts run on any node according to the load balance of resources. When the number of service nodes is zero, all virtual hosts cannot work normally and cannot be resumed until the nodes are repaired and restarted. The service nodes are responsible for providing physical resources to the virtual hosts, and the virtual hosts are responsible for carrying user applications. The taking two out of N for virtual hosts refers to providing mutual check among hosts and input/output voting functions in an application layer, and has nothing to do with the service nodes.

The physical resource pool is an abstract summary of all nodes and has no entity, but it contains available resources of all service nodes, in which occupied resources exist on the running application microservices. By recycling and allocating resources, the cloud management center redistributes the physical resource pool.

In a proposed architecture, a scheme for management nodes based on cloud fault-tolerant technology adopts a one-master multiple-slave deployment architecture, which provides logistics management guarantee for safety-critical application microservices, prevents brain split, and realizes remote disaster-tolerant in different places. The identity election of the master management node of the cloud management center adopts the weight method. Among the odd management nodes, the master management node is elected by the identity weight, and survival of management nodes is confirmed through heartbeat. Each management node keeps the identity weights of all nodes. Once a certain node cannot be detected, its identity weights recorded in other nodes are punished. Odd number of management nodes receive user requests at the same time, but only one management node executes commands, so that the load balance of requests is satisfied and the processing efficiency of platform requests is improved.

For distributed task nodes, the fault-tolerant application scheme adopts dynamic redundancy application fault-tolerant method to maintain the life cycle and normal operation of application microservices. The fault-tolerant scheme takes health check, fault restart or migration, and data inheritance as design mechanisms, takes safety computing and fault safety as design concepts, and takes protecting applications and data and filtering and offsetting application running errors as design aims to build a secure computing platform on the cloud.

In the application fault tolerance, the virtual hosts introduce the design concept of secure computing, and designs a scheme of taking two out of N. Among N created virtual hosts, as long as the number of alive hosts is greater than or equal to two, the secure computing platforms included in the cloud platform still vote and apply normally. The purpose of voting is to filter the application running errors running on the virtual hosts, such as running suspension, abnormal running and other fault factors. The voting results follows a principle that the minority is subordinate to the majority. Once voting results of a certain host are not equal to voting results of the majority of hosts, the host performs fault restart and data inheritance, and recovers to an initial application state with latest variable data.

In an underlying platform mechanism adopted by the application fault-tolerant scheme, health check is responsible for detecting and guaranteeing the life cycle of the application microservices, and after the application is abnormally suspended, a new replica is restarted by itself according to a basic mirroring. The fault restart or migration mechanism restart and recover after the application microservices fail, and at the same time, an appropriate node location for recovery and deployment is selected according to a resource usage of each service node. The data inheritance mechanism recovers non-persistent data that has been emptied and destroyed after the application is restarted. In other words, the virtual hosts undergoing fault restart inherits historical application data from normal virtual hosts, so as to ensure hosts undergoing fault restart to inherit a task progress of existing normal virtual hosts, thus meeting a design concept of fault safety.

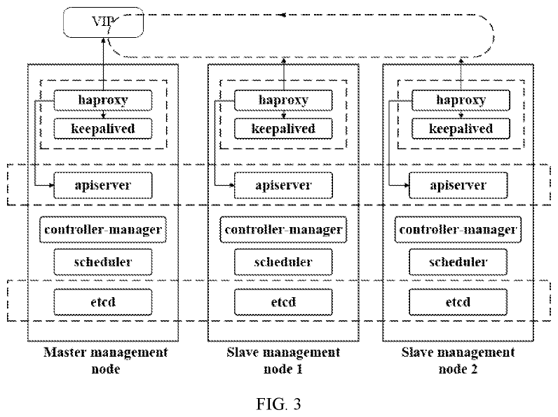

A schematic diagram of the cloud management fault-tolerant scheme provided by the embodiment of the present application is shown in FIG. 3.

The implementation scheme is based on Kubernetes, a PaaS cloud platform, to design and implement the cloud fault-tolerant method, but it does not restrict the specific cloud platform and cloud computing implementation scheme. The platform management section depends on API server component, Scheduler component, Controller Manager component and Etcd component. The specific functions and responsibilities of each component are shown as follows.

The API server is responsible for communicating with other management node components. It is an only entrance for all API operations and an entrance process for cluster control.

The Scheduler component is responsible for allocating application resources and scheduling pod node locations.

The Controller Manager component is responsible for performing platform-level functions, such as copying components, continuously tracking work nodes, and handling startup failure nodes.

The Etcd component is responsible for persistently storing cluster configuration.

Considering that the functions of the Scheduler responsible for scheduling and the Controller-manager responsible for copy control of the platform are unique, many of them conflict with each other, so it is not built in the form of multi-master. In the one-master multi-slave architecture scheme, an odd number of Scheduler and Controller-manager confirm the unit components that need to perform functions through election to avoid component conflicts. API server, responsible for executing user requests, receives user requests at all management nodes at the same time, so that a demand of remote disaster recovery by the cloud platform is satisfied. In other words, distributed processing of user requests for creating, deleting and querying applications is realized.

The platform provides Etcd component to store configuration data for application creation and initialization. The Etcd component is located on each management node or separated from the management nodes to form a distributed configuration data storage center.

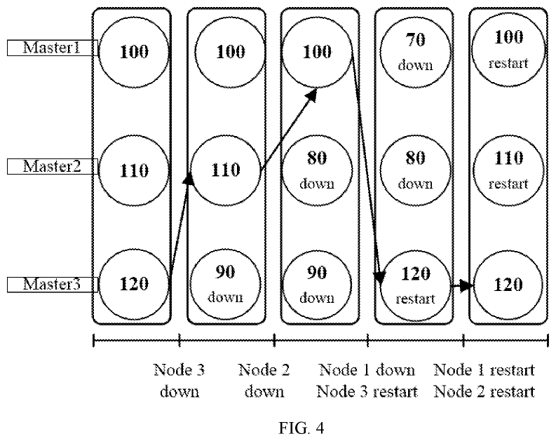

A schematic diagram of an adjustment process of the identity weights provided by an embodiment of the present application in the case of downtime and restart is shown in FIG. 4.

The implementation scheme of management fault tolerance is based on KeepAlived and Haproxy component scheme. The implementation scheme of management fault tolerance adopts virtual IP drift strategy based on a weight method. The KeepAlived component of each node records the initial identity weights of all nodes, and a largest one is the master management node.

KeepAlived adjusts the weight of each node by executing script commands to detect the Haproxy state. When the Haproxy state cannot be detected, the weight of KeepAlived subtracts a set penalty value. In the drift strategy, a weight change process is adjusted by adding a trigger condition of weight adjustment and a corresponding penalty value, so as to adapt to different application deployment requirements.

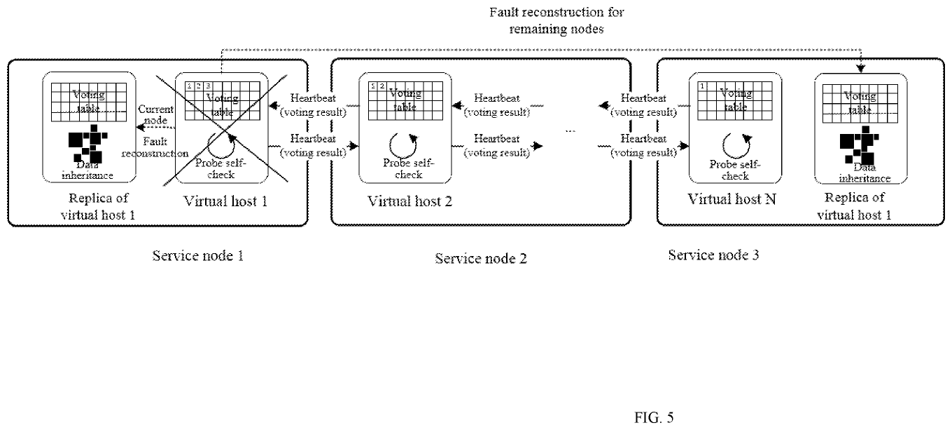

A process diagram of the application fault-tolerant method of dynamic redundancy provided by the present application is shown in FIG. 5.

The application fault-tolerant implementation scheme adopts passive fault-tolerant mechanism. With the passive fault-tolerant mechanism, when a fault occurs, in-time response and quick recovery are provided. It is unnecessary to detect many fault sources of cloud platform, including lower hardware infrastructure and upper software applications one by one, thus improving the efficiency of fault handling. The Application fault-tolerant scheme includes an in-host self-check scheme based on health check, a host mutual check scheme based on heartbeat mechanism and a fault-tolerant mode based on dynamic redundancy.

The in-host self-check scheme based on health check realizes the life cycle monitoring and management of virtual hosts, and main monitoring objectives are whether the application is successfully initialized and runs normally. Kubernetes, an open source PaaS cloud platform, is taken as an example. Its component Kubelet is implanted with Readiness Probe and Liveness Probe when the virtual hosts are created. The former determines whether the application is ready and can accept external communication traffic. In other words, the former detects whether the virtual hosts are fully started. The latter determines when to restart an application container. In other words, the former monitors faults situation of virtual hosts, such as termination and deadlock etc., and performs a health check on the virtual hosts to realize the fault restart. The restart location may be a current physical node or other physical nodes.

The host mutual check scheme based on heartbeat mechanism is responsible for a mutual health check among hosts. Only heartbeat information is sent without heartbeat response. The heartbeat information is a voting result of each virtual host plus a timestamp when the voting result is generated. Each virtual host has a voting table to collect voting results of each virtual host. This design has the advantage that the voting results are generated first, and the voting results of enough other virtual hosts are collected first, so as to give priority to output. In other words, when a first unit in the voting table is a local host, its virtual local host is allowed to output, thus avoiding the simultaneous output of multiple virtual hosts occupying the bandwidth of the external network.

The implementation scheme of application fault tolerance adopts fault tolerance mode based on dynamic redundancy. In this mode, a monitoring of faults of a single host or multiple hosts is realized by in-virtualized host self-check and heartbeat among virtualized hosts, and the fault tolerance is realized by reorganizing the whole system, destroying and replacing failed hosts, without covering up the fault effect through resource stacking.

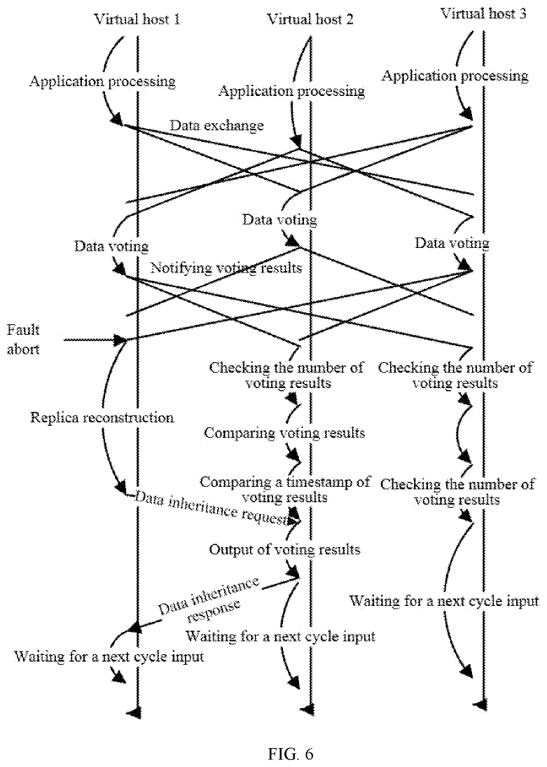

A schematic diagram of data inheritance timing during fault recovery provided by the present application is shown in FIG. 6.

A data inheritance mechanism of the present application is used to solve the handover and transmission of legacy data history, and to prevent the data loss when the virtual hosts log off or restart due to failure. When the virtual hosts work normally, the data variables on the virtual hosts providing with same voting results are all same, and different virtual hosts may be variable storage areas for each other. A failed host chooses to inherit an internal state information of the application of a surviving virtual host based on the communication mode, dump memory variables, overcome the one-to-one limitation of physical host data storage and application, and complete a data recovery.

A process of data recovery is as follows: after a corresponding management component destroys the virtual host container and recycles resources of the virtual host container to a resource pool, the corresponding management component redistributes resources of the virtual hosts and rebuild another copy of the application. When an old host is destroyed and a new replica is built, the new replica host sends a data inheritance request to the existing virtual hosts when the new replica host starts initialization, and the existing virtual host transmits the data variables in its own buffer area to the new replica host while responding to the data inheritance request, so as to achieve data inheritance.

### Embodiment 2

The present application also provides a cloud safety computing device based on cloud fault-tolerant technology and the cloud safety computing device based on cloud fault-tolerant technology includes:

a fault-tolerant management module used for management nodes to adopt a one-master multi-slave fault-tolerant architecture, and using KeepAlived and Haproxy to realize a self-check of the management nodes liveness and a load balancing of user requests;

an application fault-tolerant module used for service nodes to maintain a life cycle of the application microservices by adopting a dynamic redundancy fault-tolerant safety design, and to give feedback on liveness information to the management nodes in real time through heartbeat;

Among them, the application microservices report the life cycle to the management nodes based on a probe mechanism, and the application microservices exchange input and output information through redundancy voting.

### Embodiment 3

The present application also provides a storage medium. The storage medium stores machine executable instructions, and when the machine executable instructions are called and executed by a processor, the machine executable instructions urge a processor to realize a cloud safety computing method based on cloud fault-tolerant technology.

The above-mentioned embodiments only describe the preferred modes of the present application, but do not limit the scope of the present application. On the premise of not departing from the design spirit of the present application, all kinds of modifications and improvements made by ordinary technicians in the field to the technical scheme of the present application shall fall within the scope of protection determined by the claims of the present application.

What is claimed is:

1. A cloud safety computing method based on cloud fault-tolerant technology, comprising following steps:
S1, adopting a one-master multiple-slave fault-tolerant architecture for management nodes, and using KeepAlived and Haproxy to realize a liveness self-check of the management nodes and a load balancing of user requests; and
S2, adopting a dynamic redundancy fault-tolerant safety design for service nodes to maintain a life cycle of application microservices, and giving feedback on liveness information to the management nodes in real time through heartbeat by the service nodes;
wherein the application microservices report the life cycle to the management nodes based on a probe mechanism, and the application microservices exchange input and output information through redundancy voting.

2. The cloud safety computing method based on cloud fault-tolerant technology according to claim 1, wherein in S1, the Haproxy is responsible for network proxy, forwarding user requests, and recording and counting throughput, status, start and stop times of a monitoring object apiserver; the Keepalived, as a reverse proxy server, periodically detects a running state of the Haproxy by dual-machine hot standby.

3. The cloud safety computing method based on the cloud fault-tolerant technology according to claim 2, wherein in S1, a master management node is elected by an adjustable weight method.

4. The cloud safety computing method based on cloud fault-tolerant technology according to claim 3, wherein in S2, a secure computing platform designs an application layer by adopting a redundancy principle of two out of N, wherein N is greater than or equal to 2; the secure computing platform comprises multiple virtual hosts, and the virtual hosts call an input and output of user services through interfaces and vote synchronously.

5. The cloud safety computing method based on cloud fault-tolerant technology according to claim 4, wherein Readiness probe and Liveness probe are adopted to realize a health check of the secure computing platform including user services at intervals in the whole life cycle; the Readiness probe is responsible for checking whether the virtual hosts are ready to start and start working normally, and the Liveness probe is responsible for probing whether the virtual hosts are alive.

6. The cloud safety computing method based on cloud fault-tolerant technology according to claim 5, wherein when the virtual hosts fail, replicas are restarted and nodes are migrated; when the virtual hosts fail and physical resources of nodes where the virtual hosts are located are sufficient, Docker container technology is used to create initialized virtual host replicas by using a mirroring; if the infrastructure resources of the nodes where the virtual hosts are restarted are insufficient, the virtual hosts migrate to other alive service nodes to achieve load balancing.

7. The cloud safety computing method based on cloud fault-tolerant technology according to claim 6, wherein when the virtual host fail, data of initialized virtual host replicas is inherited from other virtual hosts; each alive virtual host is a memory variable storage area for each other; wherein an inherited data information includes: a communication address of a current output host, a communication address of a client receiving output data, user service-related data and communication-related information.

8. A cloud safety computing device based on cloud fault-tolerant technology, comprising:
a fault-tolerant management module used for the management nodes to adopt a one-master multi-slave fault-tolerant architecture, and using KeepAlived and Haproxy to realize a liveness self-check of management nodes and a load balancing of user requests, and
an application fault-tolerant module used for service nodes to maintain a life cycle of application microservices by adopting a dynamic redundancy fault-tolerant safety design, and to give feedback on liveness information to the management nodes in real time through heartbeat,
wherein the application microservices report the life cycle to the management nodes based on a probe mechanism, and the application microservices exchange input and output information through a redundancy voting.

9. A storage medium, wherein the storage medium stores machine executable instructions; when called and executed by a processor, the machine executable instructions urge the processor to realize the cloud safety computing method based on cloud fault-tolerant technology according to claim 1.
